(19) United States
(12) Patent Application Publication
(10) Pub. No.: US 2025/0387288 A1
(43) Pub. Date: Dec. 25, 2025

(54) MASSAGE SYSTEM EMPLOYING PNEUMATIC DEVICE

(71) Applicant: HYUNDAI TRANSYS INC., Seosan-si (KR)

(72) Inventors: Gu Chang KANG, Hwaseong-si (KR); Ui Jeong LEE, Hwaseong-si (KR); J Edgar CALINGACION, Osan-si (KR)

(21) Appl. No.: 19/238,341

(22) Filed: Jun. 13, 2025

(30) Foreign Application Priority Data
Jun. 25, 2024 (KR) 10-2024-0082657

(51) Int. Cl. A61H 15/00

(52) U.S. Cl. CPC A61H 15/0078; A61H 2015/0014; A61H 2201/0103; A61H 2201/0149; A61H 2201/0192; A61H 2201/1207; A61H 2201/14; A61H 2201/1623; A61H 2201/5056; A61H 2201/5064; A61H 2201/5071; A61H 2205/081

(57) ABSTRACT

The present disclosure relates to a massage system for a seat. The massage system includes a pneumatic device provided in a seatback of the seat, the pneumatic device including a plurality of air bladders configured to allow adjustment of air pressure, a rail disposed on the air bladders, the shape of the rail configured to be variable depending on the amount of air injected into the air bladders, and a massage module movable along the rail, the massage module including a roller configured to press against a passenger to be seated in the seat.

### CROSS-REFERENCE TO RELATED APPLICATION

This application claims priority, under 35 U.S.C. § 119(a), to Korean Patent Application No. 10-2024-0082657, filed on Jun. 25, 2024 and the entire contents of which are incorporated herein by reference.

### BACKGROUND

### (a) Technical Field

The present disclosure relates to a massage system employing a pneumatic device, wherein optimal seating comfort is provided to a passenger using the pneumatic device and the intensity of massage is adjusted.

### (b) Background Art

A massage system for massaging a passenger's back is applied to a seat mounted in a vehicle. In particular, as the spread of autonomous vehicles increases, passengers are increasingly engaged in indoor activities in vehicles, and massage systems are being installed in vehicle seats to help passengers relax and recover from fatigue.

Massage systems are categorized into a pneumatic massage system and a mechanical massage system. The pneumatic massage system uses air pressure to inflate and deflate air bladders to provide a support area that conforms to the passenger's body shape. However, the pneumatic massage system does not have enough force to pressurize the passenger, so the effectiveness of the massage is not great, and various parts such as a pneumatic valve are required. The mechanical massage system massages the passenger's back through rollers that move up and down or through an injection plate that is connected to a shaft and moves back and forth rapidly through the eccentric rotation of a motor to provide a massage effect to the passenger. The method using the rollers is typically applied to massage chairs, not vehicles, and the problem with this type of massage system is that the rollers can adversely affect the passenger's comfort if applied to the seat, and it is difficult to apply the rollers to the seat of a vehicle. In the case of the mechanical massage system, only a localized position is stroked, and therefore it is not possible to strike a suitable area according to the body of a passenger and it is difficult to satisfy the needs of a passenger who wants to receive a massage in various areas. In addition, in the event of vehicle collision, the rollers or the injection plate constituting the mechanical massage system may cause injury to a passenger.

The above information disclosed in this Background section is provided only for enhancement of understanding of the background of the present disclosure and therefore it may contain information that does not form the prior art that is already known in this country to a person of ordinary skill in the art.

### SUMMARY OF THE DISCLOSURE

The present disclosure has been made in an effort to solve the above-described problems associated with the prior art.

It is an object of the present disclosure to provide a massage system employing a pneumatic device capable of providing an optimal massage for a passenger's spinal flexion by adjusting the position of the massage module forward and backward through the pneumatic device in a seatback.

It is another object of the present disclosure to provide a massage system employing a pneumatic device capable of massaging the back of a passenger in a state of being applied to a seat, taking into account a passenger's posture.

The objects of the present disclosure are not limited to that described above. The objects of the present disclosure will be clearly understood from the following description of embodiments and could be implemented by means defined in the claims and a combination thereof.

In an aspect, the present disclosure provides a massage system for a seat employing a pneumatic device. The massage system includes a pneumatic device provided in a seatback of the seat, the pneumatic device including a plurality of air bladders configured to allow adjustment of air pressure, a rail disposed on the air bladders, the shape of the rail configured to be variable depending on the amount of air injected into the air bladders, and a massage module configured to be movable along the rail, the massage module including a roller configured to press against a passenger to be seated in the seat.

In an example, the degree to which the massage module protrudes in a direction so as to face a passenger to be seated in the seat may be adjusted based on the amount of air injected into the air bladders.

In an example, the plurality of air bladders may be disposed in two rows, and a pair of the rails may be provided so as to be disposed on the air bladders in two rows.

In an example, an uppermost bladder and a lowermost bladder are located at opposite ends, among the air bladders disposed in each of the two rows, and may be coupled to the rail by a mounting structure.

In an example, a guide portion configured to be in contact with the rail may be disposed on remaining ones of the air bladders, excluding the uppermost bladder and the lowermost bladder, and the guide portion may include a recess having a width equal to or greater than the width of the rail.

In an example, the massage module may include a pinion gear configured to be moved in engagement with a tooth portion provided on the rail.

In an example, the rail may be formed in a closed loop, the pinion gear may be configured to remain in contact with the rail at two portions.

In an example, a first portion of the pinion gear may be configured to engage the tooth portion provided on an inner surface of the rail and a second portion of the pinion gear is configured to remain in contact with a flat surface on an inner surface of the rail.

In an example, a pair of the rails may be disposed on both lateral sides of the massage module, the massage module may include a pair of guide plates disposed outside the pair of rails, and the pair of guide plates may be connected to each other via a shaft.

In an example, the pinion gear may be coupled to a link configured to prevent the pinion gear from dislodging from the corresponding rail, and the link may be shaped to extend from a center portion of the pinion gear and to surround an outer surface of the rail opposite an inner surface of the rail where the tooth portion is provided.

In an example, the pinion gear may include a bearing portion disposed radially outward of the center portion, and the bearing portion may be connected to a motor configured to move the massage module via a motor shaft.

In an example, the massage system may further include a controller configured to control the air bladders and the massage module, wherein the controller may be configured to control the amount of air injected into each of the air bladders based on the pressure applied to each of the air bladders.

In an example, the controller may be configured to determine a range of movement of the massage module based on the pressure applied to the air bladders.

In an example, the controller may be configured to exhaust the air from the air bladders disposed outside the range of movement.

In an example, the controller may be configured to determine the air bladder located at an uppermost end and the air bladder located at a lowermost end from among the air bladders pressurized to a preset pressure or higher, and the controller may be configured to determine the position of a spine of a passenger to be seated in the seat, taking into account human spine geometry and positions of the air bladders pressurized to the preset pressure or higher.

In an example, the controller may be configured to increase the amount of air injected into the air bladder corresponding to a target spine position in order to vary the pressure applied by the massage module to the position of the target spine according to a plurality of massage modes.

In an example, the controller may be configured to control the amount of air injected into each of the air bladders so as to be proportional to a target pressure of each of the air bladders.

In an example, the controller may be configured to perform emergency exhaust of all of the air bladders based on a signal about possible collision of a vehicle received from a vehicle controller mounted on the vehicle.

In an example, the massage system may further include a pressure sensor configured to measure pressure of each of the air bladders.

Other aspects and preferred embodiments of the present disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view showing a seatback having a massage system with a pneumatic device according to an embodiment of the present disclosure;

FIG. 2 is a sectional view taken along line A-A′ of FIG. 1;

FIG. 3 is a view showing the massage system with the pneumatic device according to the embodiment of the present disclosure;

FIG. 4 is a view showing a pinion gear according to an embodiment of the present disclosure;

FIG. 5 is a view showing a mounting structure according to an embodiment of the present disclosure;

FIG. 6 is a view showing a guide portion according to an embodiment of the present disclosure;

FIG. 7 is a block diagram illustrating the function of a controller according to an embodiment of the present disclosure; and

FIG. 8 is a flowchart illustrating a method of controlling the massage system with the pneumatic device according to the embodiment of the present disclosure.

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, positions, and shapes, will be determined in part by the particular intended application and use environment.

In the FIGS., reference numbers refer to the same or equivalent parts of the present disclosure throughout the several FIGS. of the drawing.

### DETAILED DESCRIPTION

Advantages and features of the present disclosure and methods for achieving the same will be clearly understood with reference to the following detailed description of embodiments in conjunction with the accompanying drawings. However, the present disclosure is not limited to the embodiments disclosed herein and may be implemented in various different forms. The embodiments are merely given to make the disclosure of the present disclosure perfect and to perfectly instruct the scope of the disclosure to those skilled in the art, and the present disclosure should be defined by the scope of claims. Like reference numbers refer to like elements throughout the specification.

The term “portion”, “unit”, or “module” used in this specification signifies one unit that processes at least one function or operation, and may be realized by hardware, software, or a combination thereof.

In addition, the terms “first” and “second” are used in this specification only to distinguish between the same elements, and the elements are not limited as to the sequence therebetween in the following description.

The above detailed description illustrates the present disclosure. In addition, the foregoing describes exemplary embodiments of the present disclosure. The present disclosure may be used in various different combinations, changes, and environments. That is, variations or modifications can be made within the conceptual scope of the present disclosure, equivalents to the disclosure of the present disclosure, and/or the scope of technology and knowledge in the art to which the present disclosure pertains. The embodiments describe the best mode for realizing the technical concept of the present disclosure, and variations required for the concrete application and use of the present disclosure are possible. Therefore, the above detailed description does not limit the present disclosure disclosed above. In addition, the appended claims should be interpreted to include other embodiments.

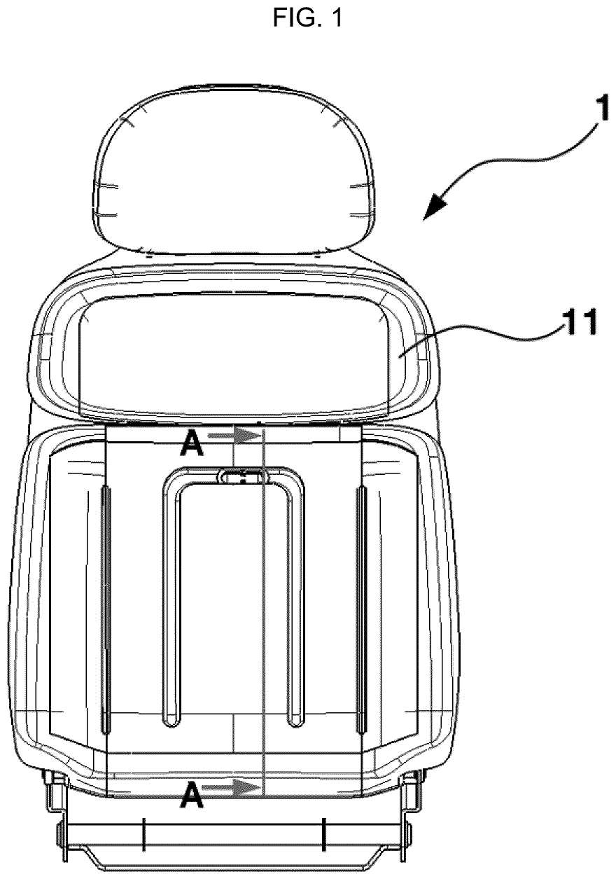

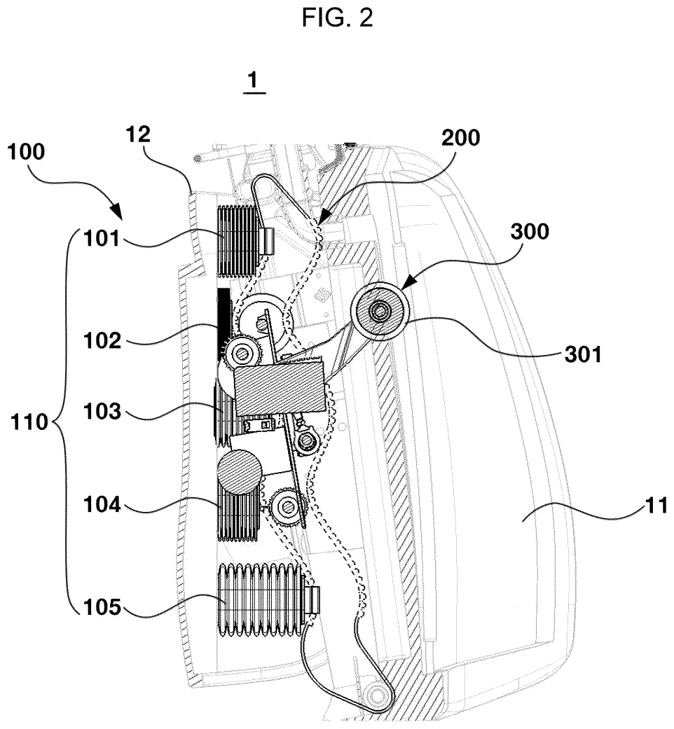

FIG. 1 is a view showing a seatback having a massage system with a pneumatic device according to an embodiment of the present disclosure, and FIG. 2 is a sectional view taken along line A-A′ of FIG. 1.

Referring to FIGS. 1 and 2, a massage system with a pneumatic device may be applied to a seatback 1 constituting a seat mounted in a vehicle. The massage system with the pneumatic device may massage the back of a passenger seated on the seat.

The massage system may include a pneumatic device 100, a rail 200, and a massage module 300. The pneumatic device 100, the rail 200, and the massage module 300 may be disposed in the seatback 1. Specifically, the pneumatic device 100, the rail 200, and the massage module 300 may be disposed in a cover 11 configured to cover the seatback 1. That is, the massage module 300 may not come into direct contact with the passenger's back even when the massage system with the pneumatic device is operated.

The pneumatic device 100 may include a plurality of air bladders 110. Each of the air bladders 110 may allow adjustment of air pressure. The pneumatic device 100 may differently control the amounts of air injected into the air bladders 110 based on the pressure applied to the air bladders 110 by seating of the passenger. The pneumatic device 100 may include a pump configured to inject air into the air bladders 110. The air bladders 110 may be disposed on a backboard 12 disposed in the seatback 1.

The air bladders 110 may be disposed in two rows in a height direction of the seatback 1. The height direction of the seatback 1 may refer to a direction from a seat cushion constituting the seat to a headrest mounted on the seatback. The height direction of the seatback 1 may be an upward-downward direction. The air bladders 110 disposed in each of the two columns may include an uppermost bladder 101, a lowermost bladder 105, and air bladders 102, 103, and 104 disposed between the uppermost bladder 101 and the lowermost bladder 105 in the height direction of the seatback 1. However, the number of air bladders 110 disposed in a row may not be particularly limited. The amounts of air applied to the air bladders 110 or the air pressures of the air bladders 110 may be different from each other.

The pneumatic device 100 may be provided with a pressure sensor configured to measure the pressure of each of the air bladders 110. For example, the pressure sensor may be provided in plural so as to be equal to the number of air bladders 110.

The rail 200 may be disposed on the air bladders 110 such that the shape thereof is variable depending on the amounts of air injected into the air bladders 110. In an example, the rail 200 may be made of a flexible material. As the amounts of air injected into the air bladders 110 increase, the rail 200 may protrude in a direction toward the point where the passenger is seated. Since the air bladders 110 are provided in plural and the rail 200 is made of a flexible material, the rail 200 may be bent and located on the air bladders 110 if control is performed such that the amounts of air provided to the air bladders 110 are different from each other. The rail 200 may be provided in two so as to be disposed on the air bladders 110 in two rows.

The massage module 300 may be moved along the rail 200 and may include a roller 301 configured to press against the passenger. The massage module 300 may perform a type of massage in which the passenger's back or spine is directly pressed by movement of the roller 301. The massage module 300 may be moved in the upward-downward direction of the seatback 1 along the rail 200, and may be moved in the direction toward the point where the passenger is seated depending on the amounts of air injected into the air bladders 110. In other words, the shape of the rail 200 may be varied in the direction toward the point where the passenger is seated depending on the amounts of air injected into the air bladders 110, and the position of the massage module 300, which may move along the rail 200, may be varied as the shape of the rail 200 is varied. The massage module 300 may include a first motor configured to move the massage module 300 in the upward-downward direction and a second motor configured to control the roller 301. The roller 301 may move in the upward-downward direction of the seatback 1 or the direction toward the point where the passenger is seated, and massage of the passenger may be performed based on the movement of the roller 301.

According to the embodiment of the present disclosure, the passenger's perceived comfort may be improved by varying the amounts of air injected into the air bladders 110 in consideration of the passenger's physical condition and seating position.

According to the embodiment of the present disclosure, the degree to which the massage module 300 protrudes in a direction facing the passenger seated in the seat may be adjusted based on the amounts of air injected into the air bladders 110, and therefore the intensity of the massage may be adjusted.

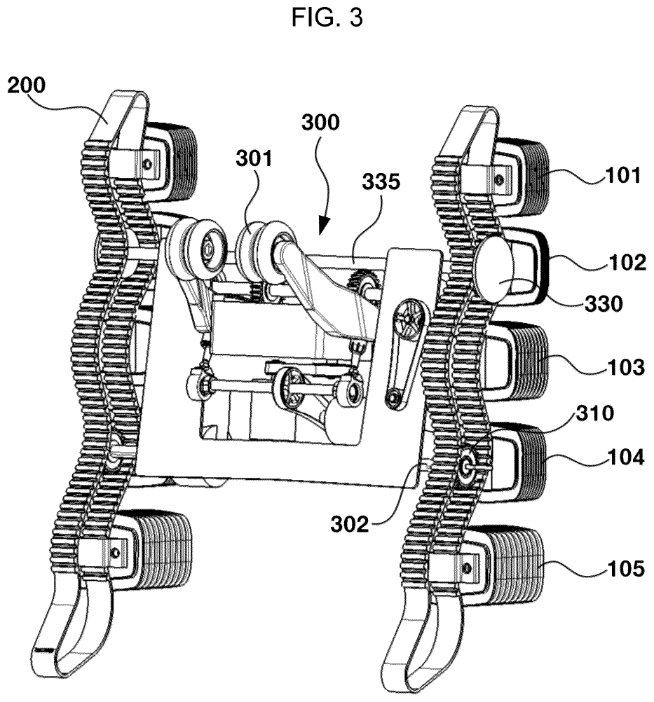

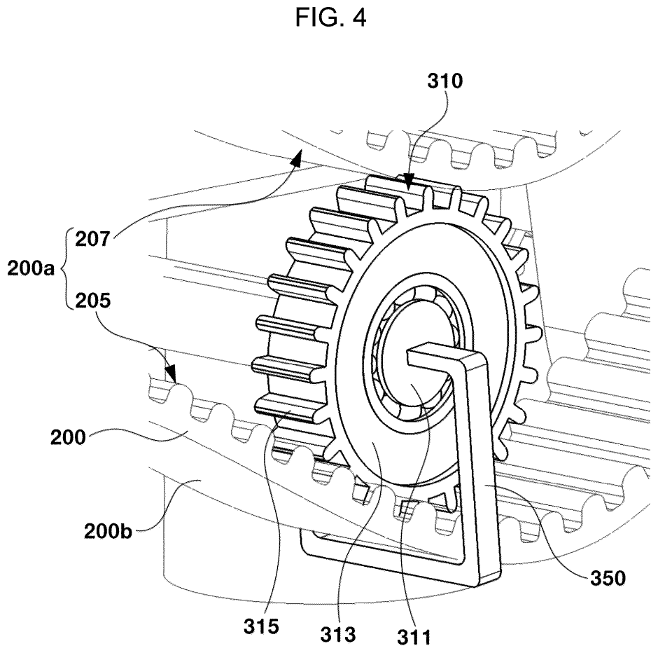

FIG. 3 is a view showing the massage system with the pneumatic device according to the embodiment of the present disclosure, and FIG. 4 is a view showing a pinion gear according to an embodiment of the present disclosure.

Referring to FIGS. 3 and 4, the air bladders 101, 102, 103, 104, and 105 may be disposed in two rows in one direction. The one direction may refer to a direction in which the air bladders 101, 102, 103, 104, and 105 are arranged. A pair of rails 200 may be provided so as to be disposed on the air bladders 101, 102, 103, 104, and 105 in two rows. The massage module 300 may be disposed between the pair of rails 200. The massage module 300 may be moved along the rails 200 by a pinion gear 310 and a guide plate 330 associated with the rails 200. The rail 200 may be a rack gear configured to engage with the pinion gear 310. The massage module 300 may be moved in the direction in which the air bladders 101, 102, 103, 104, and 105 disposed in each row are arranged.

A first portion of the pinion gear 310 may engage with a tooth portion 205 provided on an inner surface 200a of the rail 200. The pinion gear 310 may be rotated by the motor mounted to the massage module 300, and the massage module 300 may be moved along the rail 200 by rotation of the pinion gear 310. The rail 200 may include the inner surface 200a provided with the tooth portion 205 and an outer surface 200b opposite the inner surface 200a. The inner surface 200a may be divided into the tooth portion 205 and a flat surface 207 that is not provided with the tooth portion 205. A first portion and second portion of the pinion gear 310 may be configured to remain in contact with the tooth portion 205 and the flat surface 207 respectively during rotation of the pinion gear 310. The outer surface 200b of the rail 200 may be provided with teeth or may be flat.

The pinion gear 310 may include a center portion 311, a bearing portion 313, and an outer tooth portion 315. The pinion gear 310 may be coupled to a link 350 configured to prevent the same from dislodging from the corresponding rail 200. The center portion 311 may be connected to the link 350, and the center portion 311 may not be rotated. The link 350 may be shaped to extend from the center portion 311 of the pinion gear 310 and to surround the outer surface 200b of the rail 200 opposite the inner surface 200a of the rail 200 where the tooth portion 205 of the rail 200 is provided. In other words, the link 350 may extend from the center portion 311 along the axis of rotation of the pinion gear 310 so as to wrap around the outer surface 200b of the rail 200 in a bracket shape. Thus, the pinion gear 310 may not be dislodged from the rail 200 by the link 350.

The bearing portion 313 may be disposed radially outward of the center portion 311. The bearing portion 313 may be connected to the motor configured to move the massage module 300 in the upward-downward direction via a motor shaft 302.

The outer tooth portion 315 may be disposed radially outward of the bearing portion 313. The outer tooth portion 315 may be disposed on a side surface of the bearing portion 313, which is cylindrical. The outer tooth portion 315 may directly engage with the tooth portion 205 of the rail 200. As the bearing portion 313 is rotated by the motor, the outer tooth portion 315 may engage with the tooth portion 205 of the rail 200, and therefore the pinion gear 310 may be rotated on the rail 200. As the pinion gear 310 is rotated on the rail 200, the massage module 300 may be moved in one direction, e.g., the upward-downward direction.

The guide plate 330 may serve to guide the massage module 300 in one direction and to prevent the massage module 300 from moving out of position between the two rails 200. The guide plate 330 may be provided in a pair so as to be disposed outside the two rails 200 disposed on both lateral sides of the massage module 300. The pair of guide plates 330 may be connected to each other via a shaft 335. The shaft 335 may extend in a direction in which the two rails 200 face each other. The size of the guide plate 330 may be greater than the size of an empty space formed by the rail 200 forming a closed loop. In other words, the diameter of the guide plate 330 may be greater than the distance between the inner surface 200a of the rail 200 where the tooth portion 205 is disposed and the outer surface 200b of the rail 200 where the flat surface 207 is disposed. The tooth portion 205 of the inner surface 200a of the rail 200 and the flat surface 207 may face each other.

According to the embodiment of the present disclosure, instability caused during movement of the massage module 300 in one direction may be eliminated by disposing the pair of guide plates 330 in addition to the pinion gear 310 configured to move the massage module 300.

According to the embodiment of the present disclosure, the shape of the rail 200 may be varied so as to resemble the shape of the passenger's spine, which is curved, by performing control such that the amounts of air injected into the plurality of air bladders 101, 102, 103, 104, and 105 are different from each other, and therefore massage through the massage module 300 may be performed based on the shape of the passenger's spine or the passenger's seating position.

According to the embodiment of the present disclosure, the position of the roller 301 may be varied in the direction facing the point where the passenger is seated by performing control such that the amounts of air injected into the plurality of air bladders 101, 102, 103, 104, and 105 are different from each other, and therefore the passenger may receive an intense massage in a desired region.

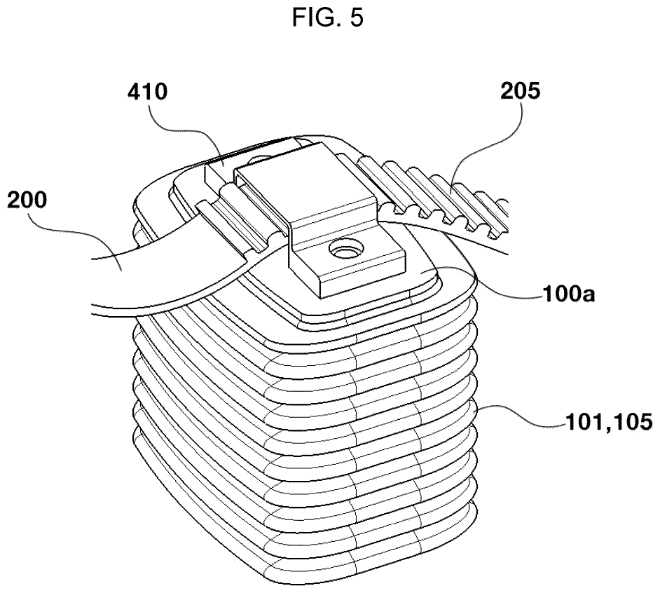

FIG. 5 is a view showing a mounting structure according to an embodiment of the present disclosure.

Referring to FIGS. 3 and 5, the plurality of air bladders 101, 102, 103, 104, and 105 may be disposed in each of the two columns. The plurality of air bladders 101, 102, 103, 104, and 105 may include the uppermost bladder 101, the lowermost bladder 105, and the remaining bladders 102, 103, and 104.

The uppermost bladder 101 may refer to an air bladder disposed at the highest position in the seat cushion constituting the seat in a direction toward the headrest. The lowermost bladder 105 may mean an air bladder disposed at the lowest position in the direction toward the headrest in the seat cushion constituting the seat.

The uppermost bladder 101 and the lowermost bladder 105, which are opposite end ones of the air bladders 101, 102, 103, 104, and 105 disposed in each of the two rows, may be coupled to the rail 200 by a mounting structure 410. The mounting structure 410 may be disposed on an upper surface 100a of each of the uppermost bladder 101 and the lowermost bladder 105. The mounting structure 410 may be fixed to the upper surface 100a of each of the uppermost bladder 101 and the lowermost bladder 105, and may include a hollow space through which the rail 200 extends. In other words, the rail 200 may be inserted into the hollow space of the mounting structure 410, and the mounting structure 410 and the rail 200 may be connected to each other. Thus, the rail 200 may be moved according to the amounts of air injected into the uppermost bladder 101 and the lowermost bladder 105, but may not be moved in one direction in which the air bladders 101, 102, 103, 104, and 105 are disposed.

The mounting structure 410 may collide with the pinion gear 310 or the guide plate 330 as the massage module 300 is moved in one direction. In order to prevent damage to the pinion gear 310 or the guide plate 330 due to collision, the mounting structure 410 may be made of a flexible material, such as rubber.

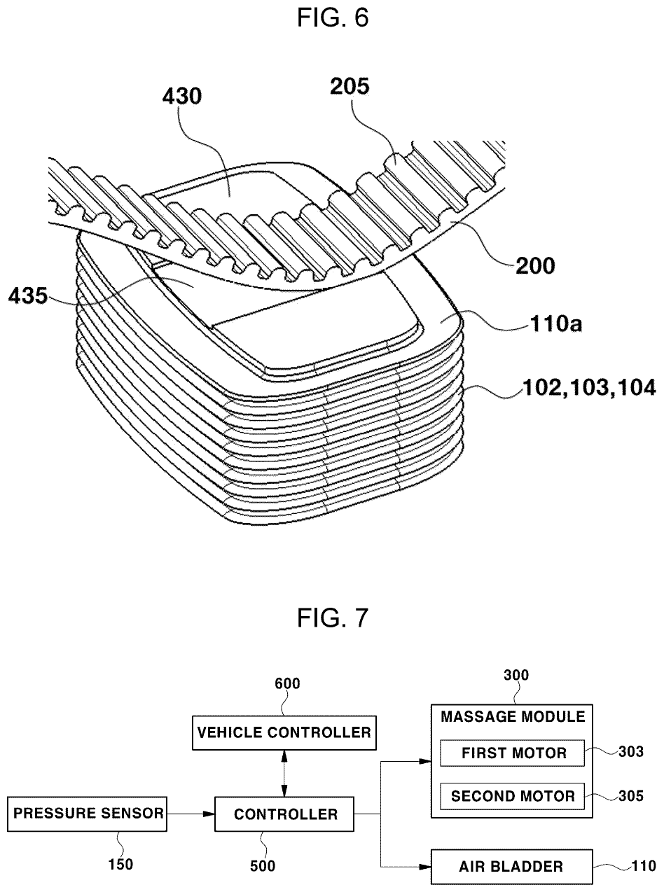

FIG. 6 is a view showing a guide portion according to an embodiment of the present disclosure.

Referring to FIGS. 3 and 6, the plurality of air bladders 101, 102, 103, 104, and 105 may be disposed in each of the two columns. The plurality of air bladders 101, 102, 103, 104, and 105 may include the uppermost bladder 101, the lowermost bladder 105, and the remaining bladders 102, 103, and 104.

A guide portion 430 configured to be in contact with the rail 200 may be disposed on the remaining bladders 102, 103, and 104, excluding the uppermost bladder 101 and the lowermost bladder 105. The guide portion 430 may be disposed on an upper surface 110a of each of the remaining bladders 102, 103, and 104. The guide portion 430 may be fixed to the upper surface 110a of each of the remaining bladders 102, 103, and 104. The guide portion 430 may include a recess 435 having a width equal to or greater than the width of the rail 200. In other words, the recess 435 may be formed in the guide portion 430 such that the recess has a width equal to or greater than the width of the rail 200 in a direction perpendicular to the direction in which the air bladders 101, 102, 103, 104, and 105 extend. Thus, the rail 200 may be located over the recess 435 of the guide portion 430. The recess 435 of the guide portion 430 does not restrict movement of the rail 200 in a direction in which each of the air bladders 101, 102, 103, 104, and 105 is inflated, but may restrict movement of the rail 200 in a direction perpendicular to the direction in which the air bladders 101, 102, 103, 104, and 105 extend. The guide portion 430 may prevent dislodge of the rail 200 in the direction perpendicular to the direction in which the air bladders 101, 102, 103, 104, and 105 extend, even if the rail 200 is moved in the direction in which each of the air bladders 101, 102, 103, 104, and 105 is inflated.

FIG. 7 is a block diagram illustrating the function of a controller according to an embodiment of the present disclosure.

Referring to FIGS. 3 and 7, the massage system with the pneumatic device may include a controller 500 configured to control the air bladders 110 and the massage module 300. The controller 500 may control the air pressure of each of the plurality of air bladders 110, and may control the position of the massage module 300 in one direction. The controller 500 may control the air bladders 110 and the massage module 300 according to a plurality of massage modes, and may control the detailed operation of the roller 301. The controller 500 may control the first motor 303 configured to move the massage module 300 in one direction and the second motor 305 configured to control the detailed operation of the roller 301.

The pressure sensor 150 may measure the pressure applied to the air bladders 110. The pressure sensor 150 may be provided in plural so as to be equal to the number of the plurality of air bladders 110. Specifically, the pressure sensor 150 may be installed in a port through which air provided to each of the air bladders 110 is discharged to measure the pressure of each of the air bladders 110. The controller 500 may control the amount of air injected into each of the air bladders 110 or the air pressure of each of the air bladders 110 based on the pressure applied to each of the air bladders 110.

As an example, the controller 500 may increase the air pressure of the associated air bladders 110 or the amount of air injected into the air bladders 110 based on a higher pressure value derived by the pressure sensor 150. The pressure value derived by the pressure sensor 150 may be obtained in the unit of mV. A high pressure value derived by the pressure sensor 150 may indicate that the pressure applied to the associated air bladders 110 as the passenger is seated in the seat is high. In order to increase the force supporting the passenger's back, therefore, the controller 500 may increase the amount of air or air pressure injected into the air bladders 110 having higher pressure values.

The controller 500 may determine the range of movement of the massage module 300 based on the pressure applied to the air bladders 110. If the pressure of a specific air bladder 110 measured by the pressure sensor 150 is less than a preset pressure, the controller 500 may determine that it is not necessary to move the massage module 300 to the position corresponding to the specific air bladder 110. If the passenger is a short person or a child, a relatively lower pressure may be applied to an air bladder 110 that is disposed at a relatively high position. Thus, it may not be necessary for the massage module 300 to be moved to the position of the air bladder 110 where no or very little pressure is exerted by the passenger's back. The controller 500 may determine the range of movement of the massage module 300 based on the air bladders 110 having pressure, measured by the plurality of pressure sensors 150, equal to or greater than the preset pressure. The controller 500 may exhaust the air from the air bladders 110 that are disposed outside the determined range of movement. At least one air bladder 110 disposed outside the range of movement need not be filled with air, and air in the at least one air bladder 110 disposed outside the range of movement may be exhausted.

For example, if the pressure of the uppermost bladder 101 is less than a preset pressure value of 50 mV and the pressure of the remaining bladders 102, 103, 104, and 105 is equal to or greater than the preset pressure, the controller 500 may determine that the range of movement of the massage module 300 is within a range of positions corresponding to the remaining bladders 102, 103, 104, and 105 except for the uppermost bladder 101. In this case, the massage module 300 may not be moved to the height at which the uppermost bladder 101 is located, and the controller 500 may exhaust all of the air in the uppermost bladder 101.

The controller 500 may determine the position of the passenger's spine, taking into account the human spine geometry and the pressure applied to the air bladders 110. The values contemplated for human spine geometry may be typical in that these values are average, median, ordinary, or the like.

As an example, the controller 500 may determine the position of the passenger's spine by deriving the air bladder 101, 102, 103, 104, or 105 disposed at the uppermost end and the air bladder 101, 102, 103, 104, or 105 disposed at the lowermost end from among the air bladders 101, 102, 103, 104, and 105 pressurized to the preset pressure or higher. That is, the approximate length of the passenger's back may be determined based on the range of pressure that the passenger applies to the air bladders 101, 102, 103, 104, and 105, and the controller 500 may determine which air bladder 101, 102, 103, 104, or 105 is matched by the position of the passenger's spine, taking into account the general spine shape of a person.

As another example, the position of a specific air bladder 110 that has the lowest pressure derived by the pressure sensor 150 among the air bladders 110 may be the position that corresponds to the lumbar vertebra of the passenger. When the passenger is seated in the seat, the pressure applied to the seatback by the lumbar vertebra portion of the passenger may be lower than the pressure applied to the seatback by other portions of the passenger's back. Specifically, the lumbar vertebra portion of the passenger may be, but is not limited to, a portion corresponding to lumbar vertebra L3. The human lumbar vertebra may include five vertebrae extending downward from the thoracic spine, and the human lumbar vertebra may be categorized by position as L1 (lumbar vertebra 1), L2 (lumbar vertebra 2), L3 (lumbar vertebra 3), L4 (lumbar vertebra 4), and L5 (lumbar vertebra 5). Specifically, in a direction away from the human head, the lumbar vertebra may be categorized as L1, L2, L3, L4, and L5.

The controller 500 may perform control such that the amount of air injected into a specific air bladder 110 having the smallest pressure applied thereto among the air bladders 110 is less than the amount of air injected into the air bladders other than the specific air bladder 110. That is, the pressure applied to the seatback by the passenger may be measured by the pressure sensors 150 associated with the air bladders 110, and the amount of air injected into the air bladders 110 may be controlled to be proportional to each of the pressures of the air bladders 110 measured by the pressure sensors 150. Determining the position of the passenger's spine based on the pressure applied to the air bladders 110 may be performed in the state in which all of the air bladders 110 are filled with a certain level of air at the time the massage system is activated.

The controller 500 may store various kinds of information, such as the plurality of massage modes, a target massage region targeted by each massage mode, and a method of controlling the roller 301. The controller 500 may adjust the pressure applied to a target spine position differently by the massage module 300 based on the plurality of massage modes. The pressure applied by the massage module 300 may be adjusted based on the amount of air injected into the air bladder 110 located at the height corresponding to the target spine position. This is because the degree to which the massage module 300 protrudes in the direction toward the passenger seated in the seat is adjusted based on the amount of air injected into the air bladders 110.

The controller 500 may control the air bladders 110 based on information about driving of a vehicle received from a vehicle controller 600. The vehicle controller 600 may include an electronic control unit (ECU) capable of determining a potential for collision of the vehicle. Furthermore, the vehicle controller 600 may include an electronic control unit (ECU) configured to control autonomous driving of the vehicle. The vehicle controller 600 may predict whether the vehicle is likely to collide with another vehicle. The controller 500 may perform emergency exhaust of the air bladders 110 based on a signal about possible collision of the vehicle received from the vehicle controller 600. Emergency exhaust may mean exhausting all of the air from the air bladders 110. The emergency exhaust may increase the distance between the massage module 300 and the passenger's back, and may prevent the massage module 300 from physically harming the passenger in the event of vehicle collision.

The controller 500 may control the air bladders 110 based on information about the rotation of the vehicle received from the vehicle controller 600. For example, if the vehicle is making a left turn, the controller 500 may control the air bladders 110 such that the amount of air injected into the air bladders 110 disposed on the left side of the passenger is greater than the amount of air injected into the air bladders 110 disposed on the right side of the passenger based on the left turn driving information received from the vehicle controller 600. That is, in order to prevent the passenger's body from tilting from side to side according to driving of the vehicle, the controller 500 may control the amount of air injected into each of the air bladders 110 based on information received from the vehicle controller 600.

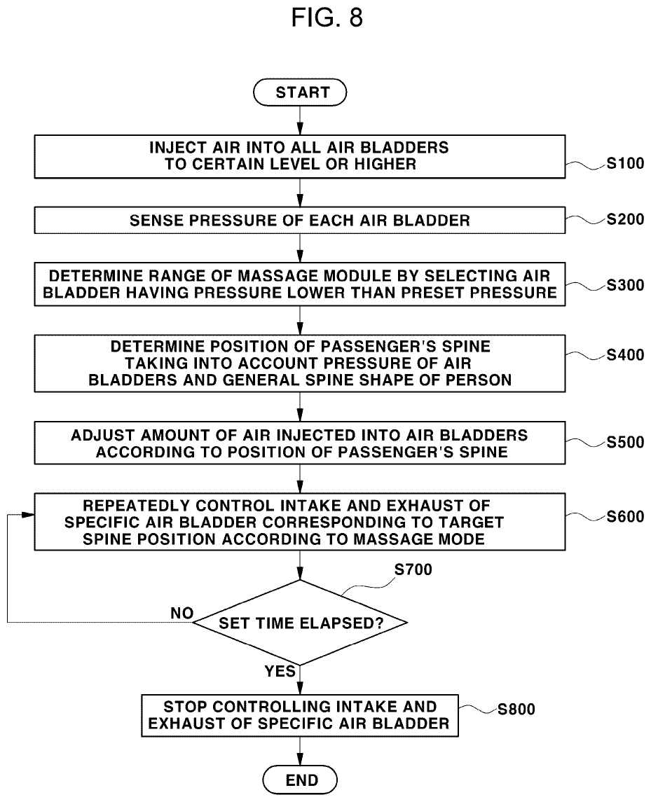

FIG. 8 is a flowchart illustrating a method of controlling the massage system with the pneumatic device according to the embodiment of the present disclosure.

Referring to FIG. 8, when the massage system is activated, air may be injected into all of the air bladders to a certain level or higher. The amounts of air injected into the air bladders may be the same, but the amounts of air injected into the air bladders may be different from each other based on information pre-stored in the controller (S100).

The pressure sensors may sense the pressure applied to the air bladders by the passenger seated in the seat. The pressure sensors may measure the pressure of each of the air bladders, taking into account the amount of air pre-injected into the air bladders (S200).

The controller may select air bladders having pressure lower than a preset pressure. For example, the preset pressure may be a value preset by a designer. The controller may determine a range of movement of the massage module, taking into account the positions of the remaining air bladders, excluding the air bladders having pressure lower than the preset pressure (S300).

The controller may determine the position of the passenger's spine by deriving the air bladder disposed at the uppermost end and the air bladder disposed at the lowermost end among the air bladders pressurized to pressure equal to or higher than the preset pressure. That is, the approximate length of the passenger's back may be determined according to the range of pressure applied to the air bladders by the passenger, and the controller may determine which air bladders are matched by the position of the passenger's spine, taking into account the general spine shape of a person. For example, the part of the passenger's lumbar vertebra corresponding to L3 may correspond to the position of the air bladder disposed at the lowermost end, and the passenger's shoulder may correspond to the position of the air bladder disposed at the uppermost end (S400).

The controller may adjust the amount of air injected into the air bladders according to the position of the passenger's spine. The controller may control the amount of air injected into the air bladders in proportion to the pressure applied to the air bladders. The pressures applied to the air bladders may be different from each other depending on the position of the passenger's spine, and the controller may determine the position of the passenger's spine based on the pressure applied to the air bladders. The controller may provide optimal seating comfort to the passenger by adjusting the amount of air injected into the air bladders, taking into account the position of the passenger's spine (S500).

The controller may store a plurality of massage modes that may be implemented by the massage system. As the massage mode changes, the amount of air injected into the air bladders, the position of the massage module, and the method of controlling the roller may vary. The controller may store a target spine position based on the massage mode, and may store information about the air bladder corresponding to the target spine position. For example, if the massage mode is a lumbar massage mode, the controller may inflate the lowermost air bladder corresponding to the position of the passenger's lumbar vertebra more than the other bladders. The controller may control the position of the massage module so that the massage through the roller is performed at the target spine position, and may repeatedly control inflation and deflation of the specific air bladder corresponding to the target spine position (S600).

The controller may repeatedly control inflation and deflation of the specific air bladder for a preset time, and therefore the massage module may intensively massage a specific position of the passenger's spine (S700).

When the set time has elapsed, the controller may stop controlling inflation and deflation of the specific air bladder (S800).

As is apparent from the foregoing, according to the embodiment of the present disclosure, control may be performed such that the amounts of air injected into the air bladders are different from each other, taking into account the physical condition and seating position of the passenger, and therefore the comfort felt by the passenger may be improved.

According to the embodiment of the present disclosure, the degree to which the massage module protrudes in the direction facing the passenger seated in the seat may be adjusted based on the amount of air injected into the air bladders, and therefore the intensity of the massage may be adjusted.

According to the embodiment of the disclosure, instability caused during movement of the massage module in one direction may be eliminated by disposing the pair of guide plates in addition to the pinion gear configured to move the massage module.

According to the embodiment of the disclosure, the shape of the rail may be varied so as to resemble the shape of the passenger's spine, which is curved, by performing control such that the amounts of air injected into the plurality of air bladders are different from each other, and therefore massage through the massage module may be performed based on the shape of the passenger's spine or the passenger's seating position.

According to the embodiment of the present disclosure, the position of the massage module may be varied in the direction facing the point where the passenger is seated by performing control such that the amounts of air injected into the plurality of air bladders are different from each other, and therefore the passenger may receive an intense massage in a desired region.

According to the embodiment of the present disclosure, emergency exhaust of the air bladders may be performed based on a possible collision of the vehicle, and therefore it is possible to prevent the massage module from physically harming the passenger in the event of vehicle collision.

The embodiments of the present disclosure have been described with reference to the accompanying drawings. However, it will be apparent to those skilled in the art that the present disclosure may be embodied in specific forms other than those set forth herein without departing from the spirit and essential characteristics of the present disclosure. Therefore, the above embodiments should be construed in all aspects as illustrative and not restrictive.

What is claimed is:

1. A massage system for a seat comprising:
a pneumatic device provided in a seatback of the seat, the pneumatic device comprising a plurality of air bladders configured to allow adjustment of air pressure;
a rail disposed on the air bladders, a shape of the rail configured to be variable depending on an amount of air injected into the air bladders; and
a massage module configured to be movable along the rail, the massage module comprising a roller configured to press against a passenger to be seated in the seat.

2. The massage system according to claim 1, wherein a degree to which the massage module protrudes in a direction so as to face a passenger to be seated in the seat is adjusted based on the amount of air injected into the air bladders.

3. The massage system according to claim 1, wherein:
the plurality of air bladders is disposed in two rows, and
a pair of rails is provided so as to be disposed on the air bladders in two rows.

4. The massage system according to claim 3, wherein an uppermost bladder and a lowermost bladder are located at opposite ends, among the air bladders disposed in each of the two rows, and are coupled to the rail by a mounting structure.

5. The massage system according to claim 4, wherein:
a guide portion configured to be in contact with the rail is disposed on remaining ones of the air bladders, excluding the uppermost bladder and the lowermost bladder, and
the guide portion comprises a recess having a width equal to or greater than a width of the rail.

6. The massage system according to claim 1, wherein the massage module comprises a pinion gear configured to be moved in engagement with a tooth portion provided on the rail.

7. The massage system according to claim 6, wherein:
the rail is formed in a closed loop, and
the pinion gear is configured to remain in contact with the rail at two portions.

8. The massage system according to claim 7, wherein a first portion of the pinion gear is configured to engage the tooth portion provided on an inner surface of the rail and a second portion of the pinion gear is configured to remain in contact with a flat surface on an inner surface of the rail.

9. The massage system according to claim 6, wherein:
a pair of rails is disposed on both lateral sides of the massage module,
the massage module comprises a pair of guide plates disposed outside the pair of rails, and
the pair of guide plates is connected to each other via a shaft.

10. The massage system according to claim 6, wherein:
the pinion gear is coupled to a link configured to prevent the pinion gear from dislodging from the corresponding rail, and
the link is shaped to extend from a center portion of the pinion gear and to surround an outer surface of the rail opposite an inner surface of the rail where the tooth portion is provided.

11. The massage system according to claim 10, wherein:
the pinion gear comprises a bearing portion disposed radially outward of the center portion, and
the bearing portion is connected to a motor configured to move the massage module via a motor shaft.

12. The massage system according to claim 1, further comprising a controller configured to control the air bladders and the massage module, wherein the controller is configured to control the amount of air injected into each of the air bladders based on pressure applied to each of the air bladders.

13. The massage system according to claim 12, wherein the controller is configured to determine a range of movement of the massage module based on the pressure applied to the air bladders.

14. The massage system according to claim 13, wherein the controller is configured to exhaust air from the air bladders disposed outside the range of movement.

15. The massage system according to claim 12, wherein
the controller is configured to determine the air bladder located at an uppermost end and the air bladder located at a lowermost end from among the air bladders pressurized to a preset pressure or higher, and
the controller is configured to determine a position of a spine of a passenger to be seated in the seat, taking into account human spine geometry and positions of the air bladders pressurized to the preset pressure or higher.

16. The massage system according to claim 15, wherein the controller is configured to increase the amount of air injected into the air bladder corresponding to a target spine position in order to vary the pressure applied by the massage module to the position of the target spine according to a plurality of massage modes.

17. The massage system according to claim 12, wherein the controller is configured to control the amount of air injected into each of the air bladders so as to be proportional to pressure measured at each of the air bladders.

18. The massage system according to claim 12, wherein the controller is configured to perform emergency exhaust of all of the air bladders based on a signal about possible collision of a vehicle received from a vehicle controller mounted on the vehicle.

19. The massage system according to claim 1, further comprising a pressure sensor configured to measure pressure of each of the air bladders.
